(19) United States
(12) Patent Application Publication
(10) Pub. No.: US 2008/0167963 A1
(43) Pub. Date: Jul. 10, 2008

(54) Method for Computing Price Discounts in an E-Commerce Environment

(75) Inventors: Joseph P. Bigus, Rochester, MN (US); W. Nathaniel Mills, Coventry, CT (US)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 12/054,456

(22) Filed: Mar. 25, 2008

Related U.S. Application Data
(63) Continuation of application No. 10/674,306, filed on Sep. 30, 2003.

(51) Int. Cl. G06Q 30/00

(52) U.S. Cl. 705/14; 705/400

(57) ABSTRACT

A method and structure for a set of rules processed by combining a procedural rule engine and a pattern matching inference engine to compute and apply discounts to customer orders in an electronic commerce system. The rule processing occurs in multiple phases. First all applicable discounts are computed. Then all allowable subsets of discounts are computed. Finally, a set of discounts is selected, based on business policies, and the discounts are applied to the order line items.

### CROSS-REFERENCE TO RELATED APPLICATIONS

This application is a Continuation of U.S. application Ser. No. 10/674,306 filed Sep. 30, 2003, the complete disclosure of which, in its entirety, is herein incorporated by reference.

### BACKGROUND OF THE INVENTION

1. Field of the Invention

The invention generally relates to the data processing field. More specifically, the invention relates to the field of electronic order processing in an electronic commerce environment.

2. Description of the Related Art

In a business-to-consumer (B2C) or business-to-business (B2B) electronic commerce environment, customer orders often contain multiple line items comprising at least a unique item identifier, such as a Stock Keeping Unit (SKU), quantity ordered, and unit price for each item being ordered. At any time, there may be multiple discounts available to the customer based on the customer's identity, date of order, identities of individual items purchased, combinations of items purchased, quantity of items purchased, and total dollar amount of the items purchased.

In Internet e-commerce sites, such as those run by IBM WebSphere® Commerce Suite, available from IBM, NY, USA, a marketing manager needs to be able to easily create new discounts to be applied to customer (or business) orders. These discounts may be applicable only at a specific date and time, and must be evaluated with other discounts that may be in effect concurrently. Also, a business policy may be employed to provide the customer with the guaranteed best price (apply the current discounts in a way to minimize the cost to the customer) or to maximize the business profit (apply the discounts in such a way to maximize the margin (customer price—cost) or some other meta-level strategy).

Current solutions compute simple discounts only. The combinatorial explosion caused by large catalogs of items, large numbers of items in individual orders, and large numbers of applicable discounts can easily overwhelm an e-commerce website. This problem is usually tackled using customized algorithms or mathematical optimization techniques such as linear programming.

Making the specification of discounts a task a business manager can perform is also difficult in today's e-commerce environment. The discount rules are typically coded in a programming language such as C, C++, or Java requiring business managers to be dependent on IT staff for even the simplest changes to rules. This causes a drain on internal company resources and adds to implementation time. Another difficulty is that adding a new discount to the e-commerce transaction may override some other discounts or cause complex interactions in terms of the impact on the best price or profit. This makes the definition and addition of new discounts costly and error prone. Thus, the conventional systems do not adequately provide solutions easily adaptable in today's e-commerce environment where speed and flexibility are essential.

Thus, there is a need for a flexible way to allow business managers to enter and remove discounts from the customer order processing system. In order to adapt to the current e-commerce environment, a new system is needed which is tolerant of overlapping or conflicting discount rules. Moreover, a novel system is needed which can scale to large numbers of items in the product catalog, large numbers of applicable discount rules, and large numbers of items in the purchase order. Therefore, there is a need for an improved system and method of computing price discounts in a B2B or B2C e-commerce environment, which allows for an accurate streamlined approach, which is easy to use and implement.

### SUMMARY OF THE INVENTION

In view of the foregoing, an embodiment of the invention provides a method of computing price discounts for an electronic commerce order and a program storage device implementing the method, wherein the method comprises categorizing all applicable price discounts for an individual customer order, computing all valid combinations of price discounts for the individual customer order, combining the valid combinations of price discounts into a price discount group, and selecting an optimal price discount based on the price discount group. The individual customer order comprises at least one order line item, wherein at least one order line item comprises a unique item identifier, a quantity ordered identifier, and a price per unit identifier for each item being ordered. The unique item identifier comprises a SKU identifier.

The applicable price discounts are based on a customer's identity, date of order, identities of individual items purchased, combinations of items purchased, quantity of items purchased, and total price of items purchased. Moreover, the price discounts comprise a fixed percentage off price discount, a fixed dollar amount off price discount, a free merchandise rebate price discount, and a combination discount thereof. Additionally, a discount object is created when a price discount ruleset is evaluated, wherein the discount object binds the price discounts to a respective item in the order. Also, the price discount object calculated by the discount ruleset are organized into groups of valid price discounts for later evaluation by the ruleset to find the optimal discount group to be applied to the order.

In another embodiment of the invention, a system for computing price discounts for an electronic commerce order is provided comprising a first unit operable for categorizing all applicable price discounts for an individual customer order, a computer configured to the first unit and operable for computing all valid combinations of price discounts for the individual customer order, a component configured to the computer and operable for combining the valid combinations of price discounts into a price discount group, a processing control mechanism configured to the component and operable for processing subsets of price discount rules within the price discount group, and a second unit configured to the component and operable for selecting an optimal price discount based on the price discount group.

The system further comprises a sequence of commands input into the computer, wherein these commands bind price discount information to a respective item in the electronic commerce order. The system also comprises a disabling mechanism configured to the computer and operable for preventing gratuitous discounts from being applied to the electronic commerce order. Additionally, the system further comprises a priority controller mechanism configured to the computer and operable for prioritizing a sequential order of evaluating the price discount rules.

The invention describes a method and apparatus for allowing the definition of discount rules and the evaluation of multiple, sometimes conflicting discount rules against a multi-item customer order to determine the “best” allowable group of discounts to be applied to the order.

The invention uses a combination of elements, including the IBM Accessible Business Rules (ABR) system to provide the date/time dependent nature of the rules, the IBM Agent Building and Learning Environment (ABLE) Rule Language and pattern match inference engines to solve the e-commerce problems articulated above.

The invention provides flexibility in that a marketing manager can identify new discounts and have them take effect, even though they may conflict with other existing discounts. The approach provided by the invention resolves the allowable discounts by applying a “meta-rule” that avoids having multiple discounts applied to the same items in the order. The rule-based inference algorithm used in the preferred embodiment of the invention provides superior performance. The basic principles of the invention could be applied to other systems where individual rules specify outcomes that abide by “meta-rules” and need subsequent evaluation to resolve conflicts and optimize the ruleset.

These and other aspects of the invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1(a) is a flowchart illustrating a method of the invention;

FIG. 1(b) is a flowchart illustrating a method of the invention;

FIG. 1(c) is a flowchart illustrating a method of the invention;

FIG. 2 is a block diagram of the components and objects used in the invention;

FIG. 3 is a block diagram of a networked computer system and e-commerce environment for use with the illustrated embodiments of the invention;

FIG. 4 is a system diagram illustrating the invention;

FIG. 5 is an example of a Discount pattern match rule represented in the ABLE Rule Language used in the illustrated embodiments of the invention; and

FIG. 6 is an example of a DiscountGroup pattern match rule represented in the ABLE Rule Language used in the illustrated embodiments of the invention.

### DETAILED DESCRIPTION OF PREFERRED EMBODIMENTS OF THE INVENTION

The invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the invention. The examples used herein are intended merely to facilitate an understanding of ways in which the invention may be practiced and to further enable those of skill in the art to practice the invention. Accordingly, the examples should not be construed as limiting the scope of the invention.

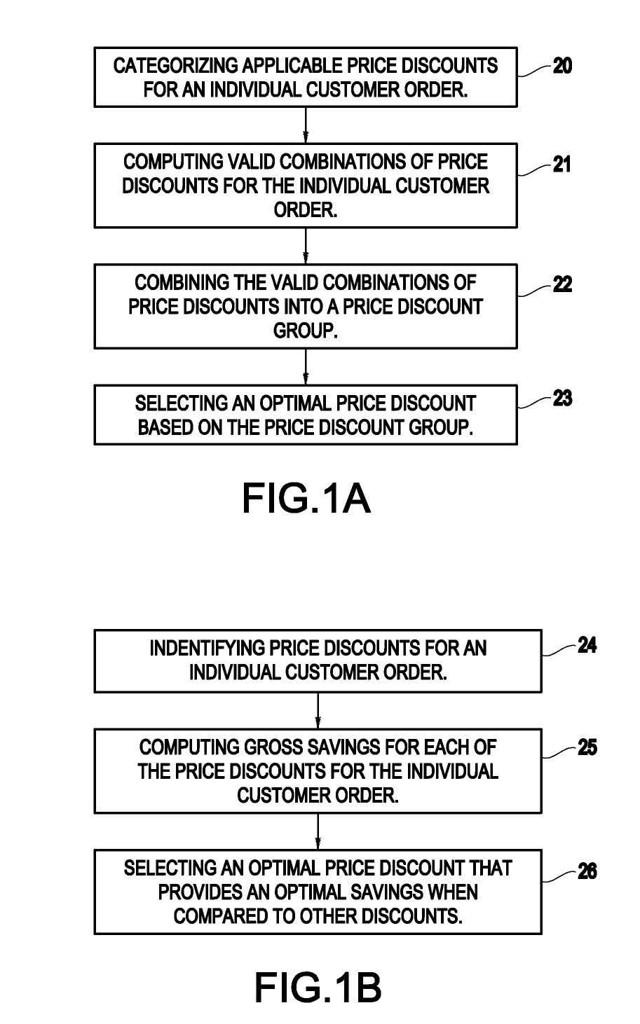

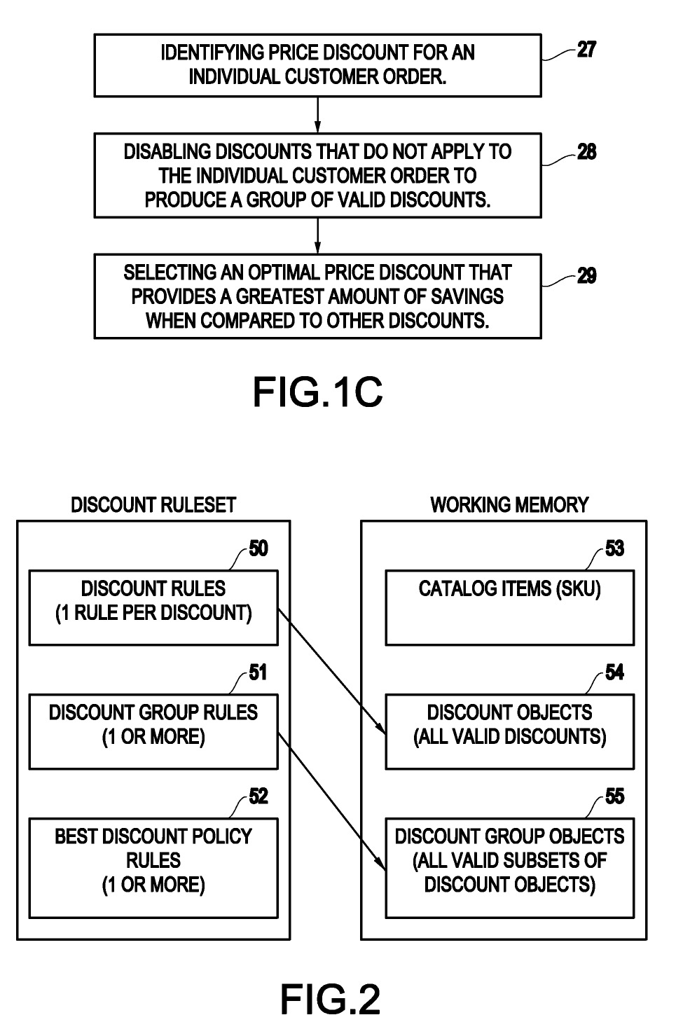

As previously mentioned, there is a need for an improved system and method of computing price discounts in a B2B or B2C e-commerce environment, which allows for an accurate streamlined approach, which is easy to use and implement. Referring now to the drawings, and more particularly to FIGS. 1 through 6, there are shown preferred embodiments of the invention including a method and structure for a set of rules processed by combining a procedural rule engine and a pattern matching inference engine used to compute and apply discounts to customer orders in an electronic commerce system. The rule processing occurs in multiple phases. First all applicable discounts are computed. Then, all allowable subsets of discounts are computed. Finally, a set of discounts is selected, based on business policies, and the discounts are applied to the order line items.

The invention uses a forward chaining pattern matching inference engine to process a set of rules to compute the customer discounts. A pattern matching inference engine utilizes caching of partial matches in an associated working memory to limit the number of tests required on the data and to improve run-time performance. The invention also uses the Rete' algorithm to process the rules and data. Those skilled in the art appreciate that other algorithms could be used to perform this caching and alternate strategies to improve the inferencing performance are known.

The invention has a single ruleset composed of multiple rules to perform three separate phases of processing. Each business-level discount rule is represented by an associated pattern match rule. Each discount rule defines one or more items identified by part number or SKU, by category (sporting goods, wine, cheese, etc.) and by the quantity of items that must be purchased for the discount to apply. A single discount rule may require that multiple specific items or items from multiple categories be present in a single order for the discount to apply. In the invention, each discount pattern match rule has a single guard clause that ensures discount rules can only fire during the initial phase of the computation. During the processing of an order, each item in the order is entered into the working memory of the pattern match engine.

As illustrated in FIG. 1(a), a preferred method of computing price discounts for an electronic commerce order is shown, whereby the process begins by categorizing 20 applicable price discounts for an individual customer order. The next step involves computing 21 valid combinations of price discounts for the individual customer order. Thereafter, the next step involves combining 22 the valid combinations of price discounts into a price discount group. The final step includes selecting 23 an optimal price discount based on the price discount group. The individual customer order comprises at least one order line item, wherein the at least one order line item comprises a unique item identifier, a quantity ordered identifier, and a price per unit identifier for each item being ordered. Moreover, the unique item identifier comprises a SKU identifier.

The applicable price discounts are based on a customer's identity, date of order, identities of individual items purchased, combinations of items purchased, quantity of items purchased, and total price of items purchased. Moreover, the price discounts comprise a fixed percentage off price discount, a fixed dollar amount off price discount, a free merchandise rebate price discount, and a combination discount thereof. Additionally, a discount object is created when a price discount ruleset is evaluated, wherein the discount object binds the price discounts to a respective item in the order. Also, the price discount object calculated by the discount ruleset are organized into groups of valid price discounts for subsequent evaluation by the ruleset to find the optimal discount group to be applied to the order.

Alternatively, as shown in FIG. 1(b) the invention provides a method of computing price discounts for an electronic commerce order comprising identifying 24 price discounts for an individual customer order, computing 25 gross savings for each of the price discounts for the individual customer order, and selecting 26 an optimal price discount that provides an optimal savings when compared to other discounts.

Additionally, as shown in FIG. 1(c) the invention provides a method of computing price discounts for an electronic commerce order comprising identifying 27 price discounts for an individual customer order, disabling 28 iscounts that do not apply to the individual customer order to produce a group of valid discounts, and selecting 29 an optimal price discount that provides a greatest amount of savings when compared to other discounts.

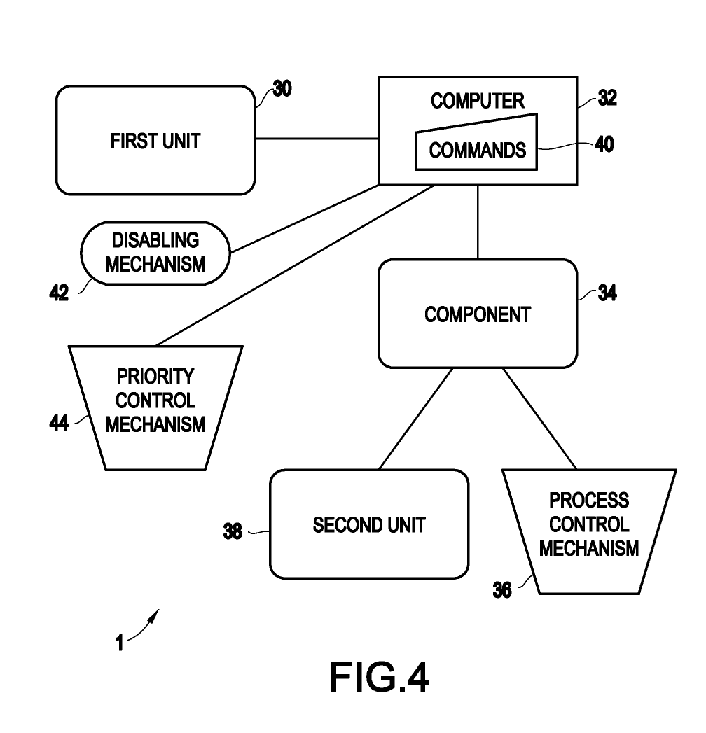

In an embodiment of the invention, a system 1 for computing price discounts for an electronic commerce order is provided and illustrated in FIG. 4, whereby the system 1 comprises a first unit 30 operable for categorizing all applicable price discounts for an individual customer order, a computer 32 configured to the first unit 30 and operable for computing all valid combinations of price discounts for the individual customer order, a component 34 configured to the computer 32 and operable for combining the valid combinations of price discounts into a price discount ruleset, a processing control mechanism 36 configured to the component 34 and operable for processing subsets of price discount rules within the price discount ruleset, and a second unit 38 configured to the component 34 and operable for selecting an optimal price discount based on the price discount ruleset.

The system 1 further comprises a sequence of commands 40 input into the computer 32, wherein the commands 40 bind price discount information to a respective item in the electronic commerce order. The system 1, shown in FIG. 4, also comprises a disabling mechanism 42 configured to the computer 32 and operable for preventing gratuitous discounts from being applied to the electronic commerce order. Additionally, the system 1 further comprises a priority controller mechanism 44 configured to the computer 32 and operable for prioritizing a sequential order of evaluating the price discount rules.

For example, the invention operates in the following manner. The customer order is presented to the first unit 30 for evaluation by the system comprising a computer 32 running the discount ruleset rules (commands 40). The discount ruleset's rules are initially evaluated against an order and its individual order line items using filters for time and other criteria to see if they are applicable (disabling mechanism 42) and are evaluated in a priority order 44. Individual discount objects (component 34) are generated and bound to the order line item evaluated by the rules. Individual discount objects are combined in discount group objects as well (component 34). The second unit 38 evaluates the Discount Group objects and finds the optimal Discount Group. The order of Discount object, Discount Group object generation and evaluation to find the optimal Discount Group is controlled by the process control mechanism 36 and later evaluated by this mechanism 36 to find the optimal set of discounts to be applied to the entire order.

In phase 0, each order item is tested against the discount pattern match rules and partial matches are cached. When a rule is triggered (each antecedent condition is met) and fired (the consequent or action part is invoked) a Discount object is created binding the discount information (percentage off, specified dollar amount off, etc.) to the item or items in the order. The combination matching of all discount rules and order items is handled by the pattern match inference engine (not shown). The result of phase 0 is a set of Discount objects generated by the firing of the discount pattern match rules that reside in the working memory of the computer 32. When no other discount pattern match rules can fire, the phase variable is incremented to 1, which disables all individual discount rules from firing. The phase variable acts as a flow control mechanism 36 to stage the processing of subsets of rules within the ruleset. ABLE further supports a concept of rule priority that can affect the order in which rules are evaluated. Priorities are used in an example to separate the rules performing work from the rules used to transition from one phase to the next. Together, the phase 36 and priority 44 are used to control which rules are fired as subsets of rules within the ruleset.

In phase 1, a set of rules is defined to take the generated set of Discount objects and combine them into one or more groups of valid discounts. A new type of object, a DiscountGroup, is created for each initial discount. The phase 1 rules take each DiscountGroup object and tries to add additional Discount objects that do not conflict with Discounts that are already part of that DiscountGroup. For example one discount may offer 10% savings when item “SKU-194” is ordered and another discount may offer $10 off when the combination of items “SKU-194” and “SKU-192” are ordered. Given the meta-rule constraint that an item may only have one discount applied, we seek to determine whether the 10% savings or $10 off results in a “better” overall discount for the order. This is dependent on quantities ordered and unit pricing of the particular order and may vary between different customer orders. The result of Phase 1 is a set of DiscountGroup objects, generated by firing the discount group pattern match rules, which reside in the working memory. When no other discount group pattern match rules can fire, the phase variable is incremented to 2. This disables all of the discount group rules from firing.

In phase 2, a set of rules is defined to take the generated set of DiscountGroup objects and select the “best” one based on a business policy defined as one or more pattern match rules. For example, the business policy may be to guarantee the customer the lowest total price, in which case the best discount pattern match rules will examine the DiscountGroup objects and select the DiscountGroup with the lowest total price (or largest total discount amount). An alternative business policy may prefer to offer overstock merchandise rather than cash discounts. When no more best discount pattern match rules can fire, the main inference cycle is complete.

FIG. 2 illustrates a block diagram of the components and objects used in the invention. As shown the Discount RuleSet corresponds with a Working Memory set. The Discount RuleSet comprises Discount price Rules 50, DiscountGroup Rules 51, and a Best Discount Policy Rules 52. The Discount Rules 50 corresponds with the Discount objects 54 of the Working Memory set, while the Discount Group Rules 51 correspond with the Discount Group objects 55. The Working Memory set also comprises catalog item identifiers 53 bound to the Discount objects to enable the rules to abide by the meta-rule that, for a particular group of discounts, no order line item may have more than one discount applied. Discount objects 54 of FIG. 2 correspond with the component 34 of FIG. 4. Discount Group objects 55 of FIG. 2 correspond with the Second Unit 38 of FIG. 4.

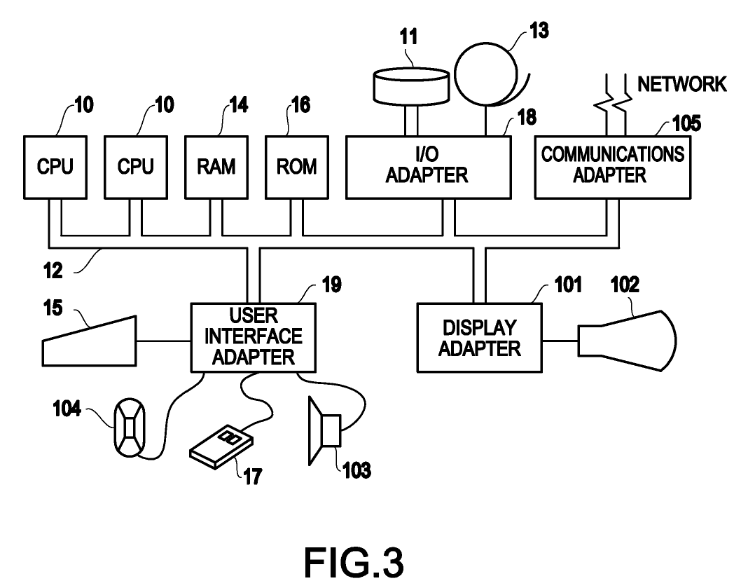

A representative hardware environment for practicing the present invention is depicted in FIG. 3, which illustrates a typical hardware configuration of an information handling/computer system in accordance with the present invention, having at least one processor or central processing unit (CPU) 10. The CPUs 10 are interconnected via system bus 12 to random access memory (RAM) 14, read-only memory (ROM) 16, an input/output (I/O) adapter 18 for connecting peripheral devices, such as disk units 11 and tape drives 13, to bus 12, user interface adapter 19 for connecting keyboard 15, mouse 17, speaker 103, microphone 104, and/or other user interface devices such as a touch screen device (not shown) to bus 12, communication adapter 105 for connecting the information handling system to a data processing network, and display adapter 101 for connecting bus 12 to display device 102. A program storage device readable by the disk or tape units is used to load the instructions, which operate the invention, which is loaded onto the computer system.

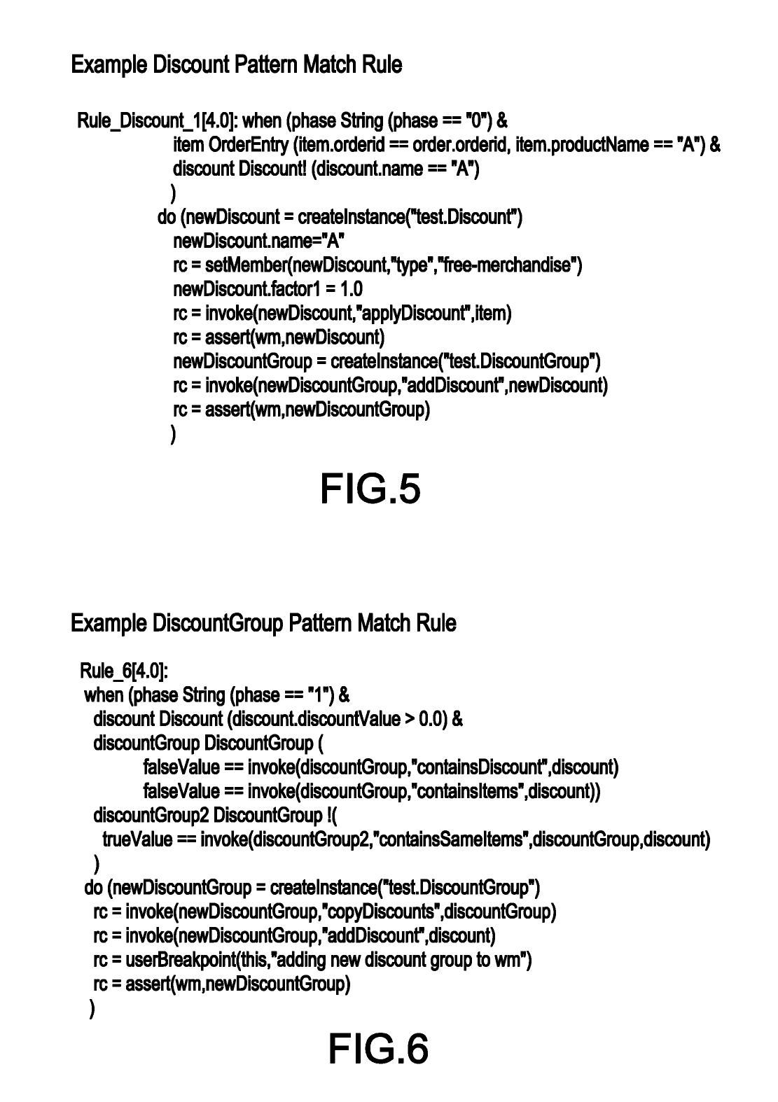

FIG. 5 is an example of a Discount pattern match rule represented in the ABLE Rule Language used in the illustrated embodiments of the invention, and FIG. 6 is an example of a DiscountGroup pattern match rule represented in the ABLE Rule Language used in the illustrated embodiments of the invention.

In a preferred embodiment of the invention, the ABLE rule language has an Idle rule block which can be used to perform end-of-processing cleanup. This can be used to remove items from the working memory and to actually apply the “best” discounts to the order line items. The following example illustrates a set of rules used in the invention:
1. Discount Rule 1: for orders with order line item with part identifier “sku-194” get twice the quantity ordered of part identifier “sku-191” free.
2. Discount Rule 2: for each order line item with part identifier “sku-190” get 20% discount.
3. Discount Rule 3: for each order line item with part identifier “sku-225” get 20% discount.
4. Discount Rule 4: for orders with order line items with part identifier “sku-194” and order line items with part identifier “sku-192” get 20% discount.
5. Discount Rule 5: for orders with order line items with part identifier “sku-192” and order line items with part identifier “sku-190” get $10 discount.
6. Discount Rule 6: for orders with order line items with part identifier “sku-225” and order line items with part identifier “sku-138” get $25 discount.
7. Discount Policy Rule 1: no order line item may have more than one Discount Rule applied.
8. Discount Policy Rule 2: Discount Rules should be applied to maximize the savings (discount amount) on the sum of order line items.

By analyzing this set of rules, Discount Policy Rule 1 would not allow Discount Rule 1 and Discount Rule 4 to be applied to the same order because the order line item with part identifier “sku-194” would have more than one Discount Rule applied. The same is true for the following combinations of Discount Rules:
1. Discount Rule 4 and Discount Rule 5 (due to the “sku-192” conflict).
2. Discount Rule 2 and Discount Rule 5 (due to the “sku-190” conflict).
3. Discount Rule 3 and Discount Rule 6 (due to the “sku-225” conflict).

As the number of Discount Rules increases, the complexity of applying the Discount Policy Rule 1 increases dramatically. The invention reduces this complexity allowing more Discount Rules to be added and existing rules to be changed or removed, without having to manually work out the valid combinations of rules able to be applied. Furthermore, if there are N Discount Rules, the invention applies the constraints exemplified by Discount Policy Rule 1 to keep from having to evaluate all of the potential combinations of these Discount objects, reducing execution time and improving performance. By distinguishing between rules used to define discounts and rules used to manage how they are applied, the invention allows the customer to focus on the discounts they want to offer and have the rules engine manage conflicts and derive the best allowable discount (as defined in Discount Policy Rule 2) in a timely manner.

For example, the following illustrate order line items:
1. Part Identifier: “sku-194”, Quantity: 3, Unit Price: $25.00;
2. Part Identifier: “sku-192”, Quantity: 1, Unit Price: $25.00;
3. Part Identifier: “sku-225”, Quantity: 1, Unit Price: $55.00;
4. Part Identifier: “sku-226”, Quantity: 1, Unit Price: $55.00;
5. Part Identifier: “sku-138”, Quantity: 3, Unit Price: $35.00;
6. Part Identifier: “sku-133”, Quantity: 1, Unit Price: $35.00;
   and the Unit Price for Part Identifier “sku-191” is $2.50 which can be predetermined as part of the Discount Rule or determined during runtime by querying a catalog during rule execution. This points out another aspect of the invention, that supplemental information may be examined by rules to make decisions regarding discounts able to be applied.

During Phase 0 of the rule processing, the Discount Rules are applied resulting in the following potential Discounts that might be applied to the order:

From Discount Rule 1 it is seen that: DiscountA: Purchase “sku-194” get 2 free “sku-191” =$15.00.
From Discount Rule 3 it is seen that: DiscountB: Purchase “sku-225” get 20.00% discount=$11.00.
From Discount Rule 4 it is seen that: DiscountC: Purchase “sku-194” and “sku-192” get 20.00% discount=$20.00.
From Discount Rule 6 it is seen that: DiscountD: Purchase “sku-225” and “sku-138” get $25.00 discount=$25.00.

During Phase 1 of the rule processing, these potential Discounts are then combined applying Discount Policy Rule 1 resulting in the following DiscountGroups:

DiscountGroupA=(Total Discount=$15.00 from Discount(s):
Purchase “sku-194” get 2.00 free “sku-191”=$15.00.
DiscountGroupB=(Total Discount=$11.00 from Discount(s):
Purchase “sku-225” get 20.00% discount=$11.00.
DiscountGroupC=(Total Discount=$20.00 from Discount(s):
Purchase “sku-194” and “sku-192” get 20.00% discount=$20.00.
DiscountGroupD=(Total Discount=$25.00 from Discount(s):
Purchase “sku-225” and “sku-138” get $25.00 discount=$25.00.
DiscountGroupE=(Total Discount=$26.00 from Discount(s):
Purchase “sku-194” get 2 free “sku-191”=$15.00.
Purchase “sku-225” get 20.00% discount=$11.00.
DiscountGroupF=(Total Discount=$40.00 from Discount(s):
Purchase “sku-194” get 2 free “sku-191”=$15.00.
Purchase “sku-225” and “sku-138” get $25.00 discount=$25.00.
DiscountGroupG=(Total Discount=$31.00 from Discount(s):
Purchase “sku-225” get 20.00% discount=$11.00.
Purchase “sku-194” and “sku-192” get 20.00% discount=$20.00.
DiscountGroupH=(Total Discount=$45.00 from Discount(s):
Purchase “sku-194” and “sku-192” get 20.00% discount=$20.00.
Purchase “sku-225” and “sku-138” get $25.00 discount=$25.00.

During Phase 2 of the rule processing, the Discount Policy Rule 2 is applied to determine DiscountGroupH to be the best discount allowed to be applied to the order because its Total Discount ($45.00) is greater than or equal to the Total Discount of all other Discount Groups.

By way of example, the following is the Java programmable code for an SKU item identifier class:

```
public class SKU {
  protected String productName;
  protected Double price;
  protected String category;
public SKU(String productName, Double price) {
    thisproductName = productName;
    this.price = price;
}
public SKU(String productName, Double price, String category) {
    this(productName, price);
    this.category = category;
  }
  public String getProductName( ) {return productName;}
  public Double getPrice( ) {return price;}
  public String getCategory( ) { return category;}
  public String toString( ) {
  return productName + “=(price= ”+ price + “category=” +
  category +“,)”;I
  }
}
```

By way of example, the following is the Java programmable code for a DiscountGroup class:

```
public class DiscountGroup {
  Vector discounts = new Vector( );
  Double discountTotal = new Double(0.0);
  public DiscountGroup( ) {
  }
  public void addDiscount(Discount discount) {
    discounts add(discount);
    double dct = discountTotal.doubleValue( );
    dct += discount.getDiscountValue( ).doubleValue( );
    discountTotal = new Double (dct);
  }
  public Boolean containsDiscount(Discount discount) {
    if (discounts contains(discount)) {
    return new Boolean(true);
    } else {
      return new Boolean(false);
    }
}
/**
  * Returns true if this group of discounts has been applied to an item in
  an OrderEntry
  */
  public Boolean containsItem(OrderEntry oe) {
  for (int =0; i < discounts size( ); i++) {
    Discount discount = (Discount)discounts get(i);
    if (discount containsItem(oe) booleanValue ( ) == true) return new
    Boolean(true);
  }
  return new Boolean(false);
}
/**
  * Returns true if this discount has been applied to any of the items in this
  list
  */
  public Boolean containsItems(Discount discount) {
  Vector orderEntryitems = discount.getltems( );
  for (int i=0; i < orderEntryItems.size( ); i++) {
    OrderEntry oe = (OrderEntry)orderEntryItems.get(i);
    if(containsItem(oe).booleanValue( ) == true) return new
    Boolean(true);
  }
  return new Boolean(false); // didn't find any items
}
  public String to String( ){
  return “discountGroup=(discountTotal=” + discountTotal +
  “discounts=”+ discounts +“)”;
}
}
```

By way of example, the following is the Java programmable code for an order class:

```
public class Order {
  static int nextId = 0;
  protected Double orderld;
  protected Vector orderEntries = new Vector( );
  public Order( ) {
    orderId new Double(nextId++);
  }
  public Vector getOrderEntries( ) {
    return orderEntries;
  }
  public void addOrderEntry(OrderEntry oe) {
    orderEntries.add(oe) ;
  }
  public Double getOrderId( ) {
    return ordered ;
  }
  public void selectDiscountGroup(Vector discounts) {
  }
  public String toString( ) {
  return “order=(orderId=” + orderId + “orderEntries=“+
  orderEntries +“)”;
  }
}
```

By way of example, the following is the Java programmable code for an OrderEntry class:

```
public class OrderEntry {
  static int nextId = 0
  protected Double orderEntryId ; //order entry id
  protected Double orderId; // part of
  protected SKU product ;
  protected String productName ;
  protected Double quantity ;
  protected Double totalPrice ; // quantity * price
  public OrderEntry( ) {
  orderEntryId = new Double(nextId++) ;
  }
public OrderEntry(String productName Double quantity) {
    this( );
    this.productName = productName ;
    this.quantity = quantity ;
}
public OrderEntry(SKU product. Double quantity) {
    this( );
    this.product = product;
    this.productName = product.getProductName( );
    this.quantity = quantity ;
    double tp = quantity.doubleValue( ) * product.getPrice( ).-
    doublevalue( );
    totalPrice = new Double(tp) ;
}
public Double getOrderId( ) {
    return orderId ;
}
public void setOrderId(Double orderId) {
    thisorderId = ordered ;
}
public Double getOrderEntryId( ) {
    return orderEntryId ;
}
public SKU getProduct( ) { return product ;}
publicvoid setProduct(SKU product) {
    this.product = product;
    this.productName = product.getProductName( );
}
public Double getPrice( ) { return product.getprice( ) ; }
public Double getTotalPrice( ) { return totalPrice ; }
public String getProductName( ) { return productName; }
public Double getQuantity( ) {return quantity; }
public void setQuantity(Double quantity) {
    this.quantity = quantity ;
    double tp = quantity.doubleValue( ) * product.getPrice( ).-
    doubleValue( );
    totalPrice = new Double(tp) ;
  }
  public String toString( ) {
  return “orderEntry=(id =” + orderEntryId + “orderId=” + orderId +
    “product=“+ productName + “quantity=”+ quantity + “)” ;
  }
}
```

By way of example, the following is the Java programmable code for a Discount class:

```
public class Discount {
  String name =““” ; // label used for identification
  String type = “percentage” ; // default ???
  Double factor1 = new Double(10.0) ; // defaults ???
  Double factor2 = new Double(10.0) ; // defaults ???
  Double discountValue = new Double(0.0) ;
  Vector items = new Vector( ) ; // items to which this discount has
  been applied
  public Discount( ) {
  }
  public Discount(String type, Double factor1) {
    this.type = type ;
    this.factor1 = factor1 ;
}
  public Double appllyDiscount(OrderEntry oe) {
  double discount = 0.0;
  double fact1 = factor1.doubleValue( ) ;
  double price = oe.getPrice( ).doubleValue( );
  if (type.equals(“percentageoff”)) {
    discount = fact1 * price; // factor1 is percentage
    } else if (type.equals (“free-merchandise”)) {
    discount = fact1 * price ; // factor1 = N items
    } else if (type.equals(“fixed-amount”)) {
    discount = fact1 ; // factorl = dollars
    }
    discountValue = new Double(discount) ;
    items.add(oe) ; //add item
    return discountValue ;
  }
public Double applyDiscount(OrderEntry oe1, OrderEntry oe2) {
  double discount = 0.0 ;
  double fact1 = factor1.doubleValue( ) ;
  double price1 = oe.getPrice( ).doubleValue( ) ;
  double price2 = oe.getPrice( ).doubleValue( ) ;
  if (type.equals(“percentage-off”)) {
    discount= fact1 * (price1 + price2) ; //factor 1 is percentage
  } else if (type.equals(“free-merchandise”)) {
    discount = fact 1 * (price1 + price2) ; //factor 1 = N items
  } else if(type.equals(“fixed-amount”)) {
    discount = fact1; //factor1 = dollars
  }
  discountValue = new Double(discount) ;
  items.add(oe1) ;
  items.add(oe2) ;
  return discountValue ;
  }
  public String getName( ) { return name; }
  public void setName (String name) {
    this.name = name;
  }
  public void setType(String type) {
    this.type = type ;
  }
  public void setFactor1(Double factor1) {
    this.factor1 = factor1 ;
  }
  public Double appyDiscount(Order o) {
    return new Double (0.0) ;
  }
  public double getdiscountValue( ) { return discountValue; }
  /**
  *Returns true if this discount has been applied to the item in the
  OrderEntry
  */
public Boolean containsItem(OrderEntry oe) {
  if (items.contains(oe)) {
    return new Boolean (true);
  } else {
    return new Boolean (false) ;
  }
}
/**
*Returns true if this discount has been applied to all of the items in this list
*/
public Boolean containsItems(Vector orderEntryItems) {
            for(int i=0 ; i< orderEntryItems.size( ); i++) {
              OrderEntry oe= (OrderEntry)orderEntryItems.get(i);
              if(containsItem(oe).booleanValue( ) == false) return
              new Boolean (false) ;
          }
          return new Boolean (true) ; // found all items
}
public Vector getItems( ) { return items ; }
public String toString( ) {
  return name + “=(type = ” + type + “factor1 + ”discount=“ +
  discountValue +”)” ;
}
}
```

By way of example, the following is the Java programmable code for a Discount RuleSet class:

```
RuleSet WCSDiscount1 (
    InferenceMethod(Forward2)
    Types (Order : test.Order)
    Types (OrderEntry: test.OrderEntry)
    Types(SKU: test.SKU)
    Types (Discount: test.Discount)
    Types (DiscountGroup: test.DiscountGroup)
    Types(myString : java.lang.String)
    Import(com.ibm.able.beans.rules.AbleWorkingMemoryLib)
    Variables(
        // define some products...would be loaded from DB into working memory
        productA SKU (“A”, 100.0) // Name, price
        productB SKU (“B”, 100.0) // Name, price
        productC SKU (“C”, 100.0) // Name, price
        //define a single order with 3 items -- would be passed in inputBuffer
        order Order ( )
        orderEntry 1 Order Entry ( )
        orderEntry 2 Order Entry ( )
        orderEntry 3 Order Entry ( )
        //working vars for creating active discounts and combinations of discounts
        newDiscount Discount ( )
        newDiscountGroup DiscountGroup( )
        bestGroup DiscountGroup( )
        phase myString (“0”) // turns rules on/off
        falseValue Boolean(false)
        trueValue Booelan (true)
        rc List( )
    )
    InputVars( )
    OutputVars( )
    Rules init(
        : orderEntry1.product = productA
        : orderEntry1.quantity = 1
        : orderEntry1.orderId = 0
        : orderEntry2.product = productB
        : orderEntry2.quantity = 1
        : orderEntry2.orderId = 0
        : orderEntry3.product = productC
        : orderEntry3.quantity = 1
        : orderEntry3.orderId = 0
        : rc=invoke(order, “addOrderEntry”, orderEntry1) ;
        : rc=invoke(order, “addOrderEntry”, orderEntry2) ;
        : rc=invoke(order, “addOrderEntry”, orderEntry3) ;
        : rc=assert(wm, phase)
        : rc=assert(wm, order)
        : rc=assert(wm, orderEntry 1)
        : rc=assert(wm, orderEntry 2)
        : rc=assert(wm, orderEntry3)
        : rc=assert(wm, productA)
        : rc=assert(wm, productB)
        : rc=assert(wm, productC)
    )
    Rules (
        // go in 3 phases
        // 1. generate all applicable discounts (across individual items, sets of items, and order)
        // 2. generate all applicable discount groups out of discount objects
        // 3. select appropriate discount group for order
        //
        // Single item discounts
        //
        // if phase=0 and there is an order entry with item A and a Discount for item A
        // then create a discount for that item
        Rule_Discount_1 [4]: when ( phase myString ( phase= “0”) &
            item OrderEntry (item.orderId = order.orderId),
                item.productName = “A” ) &
            discount Discount !(discount.name = “A”)
            )
        do (
          newDiscount = createInstance(“test.Discount”)
          rc= newDiscount.name “A”
          rc= newDiscount.type = “free-merchandise”
          rc= newDiscount.factorl = 1 // buy A, get 1 A free
          rc=invoke(newDiscount, “applyDiscount”, item)
          rc=assert(wm, newDiscount)
          newDiscountGroup = createInstance(“test.DiscountGroup”)
          rc=invoke(newDiscountGroup, “addDiscount”, newDiscount)
          rc=assert(wm, newDiscountGroup)
        )
    // if phase=0 and there is an order entry with item C and a Discount for item C
    // then create a discount for that item
    Rule_Discount_3 [4]: when (phase myString ( phase= “0”) &
            item OrderEntry (item.orderld = order.orderld,
                item.productName = “C”) &
            discount Discount !(discount.name “C”)
          )
        do (
          newDiscount = createInstance(“test. Discount”)
          rc= newDiscount.name = “C”
          rc= newDiscount.type = “percentage-off”
          rc= newDiscount.factor1 = 0.10 // buy C get 10% off
          rc=invoke(newDiscount, “applyDiscount”, item)
          rc=assert(wm, newDiscount)
          newDiscountGroup = createInstance(“test.DiscountGroup”)
          rc=invoke(newDiscountGroup, “addDiscount”, newDiscount)
          rc=assert(wm, newDiscountGroup)
          )
    //
    // two item discounts
    //
    // if phase=0 and there is an order entry with item A and another order entry with item B
    //  and a Discount for items A+B
    // then create a discount for those items
    Rule_Discount_2 [4]: when ( phase myString ( phase= “0”) &
            item OrderEntry (item.orderId = order.orderId),
                item.productName = “A”) &
            item2 OrderEntry (item2.orderld = order.orderId),
                item2.productName = “B” ) &
            discount Discount !(discount.name = “A+B”)
            )
        do (
          newDiscount = createlnstance(“test. Discount”)
          rc= newDiscount.name = “A+B”
          rc= newDiscount.type = “percentage-off”
          rc= newDiscount.factorl = 0.05 // buy A+B get 5% off both
          rc=invoke(newDiscount, “applyDiscount”, item, item2)
          rc=assert(wm, newDiscount)
          newDiscountGroup = createInstance(“test.DiscountGroup”)
          rc=invoke(newDiscountGroup, “addDiscount”, newDiscount)
          rc=assert(wm, newDiscountGroup)
        )
    // if phase=0 and there is an order entry with item B and another order entry with item C
    //  and a Discount for items B+C
    // then create a discount for those items
    Rule_{—} Discount_{—} 4 [4]: when ( phase myString ( phase= “0”) &
            item OrderEntry(item.orderld = order.orderld),
                item.productName = “B”) &
            item2 OrderEntry (item2.orderld = order.orderId),
                item2.productName = “C”) &
            discount Discount !(discount.name= “B+C”)
            )
        do (
          newDiscount = createInstance(“test.Discount”)
          rc= newDiscount.name = “B+C”
          rc= newDiscount.type = “fixed-amount”
          rc= newDiscount.factor1 = 10.00 // buy B+C get $10 off
          rc=invoke(newDiscount, “applyDiscount”, item, item2)
          rc=assert(wm, newDiscount)
          newDiscountGroup = createInstance(“test.DiscountGroup”)
          rc=invoke(newDiscountGroup, “addDiscount”, newDiscount)
          rc=assert(wm, newDiscountGroup)
        )
    // if phase=0 and no other rules can fire (uses priority), then go on to phase=1
    Rule_StartPhase1 [1]: when (phase myString ( phase= “0”))
        do (
          rc=retract(wm, phase)
          phase = “1”
          rc=assert(wm, phase)
        )
    //
    // order-level discounts
    //
    //
    // Generate DiscountGroups -- combinations of applicable discounts
    //
    //if phase=1 and discount group does not already contain this discount
    //  and discount group does not contain any discount with any of the same items in it
    Rule_{—} 6 [4]: when ( phase myString ( phase= “1”) &
            discount Discount (discount.discountValue > 0.0) &
            discountGroup DiscountGroup (falseValue=invoke(discountGroup,
“containsDiscount”, discount),
                falseValue=invoke(discountGroup, “containsltems”, discount))
          )
        do (
          rc=invoke(discountGroup,“addDiscount”, discount)
        )
// if phase=1 and no other rules can fire (uses priority), then go on to phase=2
Rule_StartPhase2 [1]: when (phase myString (phase= “1”))
        do (
          rc= retract(wm, phase)
          phase = “2”
          rc=assert(wm, phase)
    )
    //
    // Select “best” discount group, with maximum total discount
    //
    // Rule_8 [4]: when ( phase myString ( phase= “2”) &
    //  discountGroup1 DiscountGroup (getMember(discountGroup1, “totalDiscount”) >
0.0) &
    //  discountGroup2 DiscountGroup !(getMember(discountGroup2, “totalDiscount”) >
getMember(discountGroupl, “totalDiscount”))
    //  )
    //  do(
    //  bestGroup = discountGroup1
    //  )
)
```

The invention provides flexibility in that a marketing manager can identify new discounts and have them take effect, even though they may conflict with other existing discounts. The approach provided by the invention resolves the allowable discounts by applying a “meta-rule” that avoids having multiple discounts applied to the same items in the order. The rule-based inference algorithm used in the preferred embodiment of the invention provides superior performance. The basic principles of the invention could be applied to other systems where individual rules specify outcomes that abide by “meta-rules” and need subsequent evaluation to resolve conflicts and optimize the ruleset.

While the invention has been described in terms of preferred embodiments, those skilled in the art will recognize that the invention can be practiced with modification within the spirit and scope of the appended claims.

What is claimed is:

1. A method of computing price discounts for an electronic commerce order, said method comprising:
categorizing applicable price discounts for an individual customer order;
computing valid combinations of price discounts for said individual customer order;
combining said valid combinations of price discounts into a price discount group; and
selecting an optimal price discount based on said price discount group.

2. The method of claim 1, all the limitations of which are incorporated herein by reference, wherein said individual customer order comprises at least one order line item.

3. The method of claim 2, all the limitations of which are incorporated herein by reference, wherein said at least one order line item comprises a unique item identifier, a quantity ordered identifier, and a price per unit identifier for each item being ordered.

4. The method of claim 3, all the limitations of which are incorporated herein by reference, wherein said unique item identifier comprises a stock keeping unit (SKU) identifier.

5. The method of claim 1, all the limitations of which are incorporated herein by reference, wherein said applicable price discounts are based on a customer's identity, date of order, identities of individual items purchased, combinations of items purchased, quantity of items purchased, and total price of items purchased.

6. The method of claim 1, all the limitations of which are incorporated herein by reference, wherein said price discounts comprise a fixed percentage off price discount, a fixed dollar amount off price discount, a free merchandise rebate price discount, and a combination discount thereof.

7. The method of claim 1, all the limitations of which are incorporated herein by reference, wherein a discount object command is created when said price discount group is selected, wherein said discount object command binds said price discounts to a respective item in said order.

8. A method of computing price discounts for an electronic commerce order, said method comprising:
identifying price discounts for an individual customer order;
computing gross savings for each of said price discounts for said individual customer order; and
selecting an optimal price discount that provides an optimal savings when compared to other discounts.

9. The method of claim 8, all the limitations of which are incorporated herein by reference, wherein said individual customer order comprises at least one order line item.

10. The method of claim 9, all the limitations of which are incorporated herein by reference, wherein said at least one order line item comprises a unique item identifier, a quantity ordered identifier, and a price per unit identifier for each item being ordered.

11. The method of claim 10, all the limitations of which are incorporated herein by reference, wherein said unique item identifier comprises a stock keeping unit (SKU) identifier.

12. The method of claim 8, all the limitations of which are incorporated herein by reference, wherein said price discounts are based on a customer's identity, date of order, identities of individual items purchased, combinations of items purchased, quantity of items purchased, and total price of items purchased.

13. The method of claim 8, all the limitations of which are incorporated herein by reference, wherein said price discounts comprise a fixed percentage off price discount, a fixed dollar amount off price discount, a free merchandise rebate price discount, and a combination discount thereof.

14. The method of claim 8, all the limitations of which are incorporated herein by reference, wherein a discount object command is created when said price discount group is selected, wherein said discount object command binds said price discounts to a respective item in said order.

15. A method of computing price discounts for an electronic commerce order, said method comprising:
identifying price discounts for an individual customer order;
disabling discounts that do not apply to said individual customer order to produce a group of valid discounts; and
selecting an optimal price discount that provides a greatest amount of savings when compared to other discounts.

16. The method of claim 15, all the limitations of which are incorporated herein by reference, wherein said individual customer order comprises at least one order line item.

17. The method of claim 16, all the limitations of which are incorporated herein by reference, wherein said at least one order line item comprises a unique item identifier, a quantity ordered identifier, and a price per unit identifier for each item being ordered.

18. The method of claim 17, all the limitations of which are incorporated herein by reference, wherein said unique item identifier comprises a stock keeping unit (SKU) identifier.

19. The method of claim 15, all the limitations of which are incorporated herein by reference, wherein said price discounts are based on a customer's identity, date of order, identities of individual items purchased, combinations of items purchased, quantity of items purchased, and total price of items purchased.

20. The method of claim 15, all the limitations of which are incorporated herein by reference, wherein said price discounts comprise a fixed percentage off price discount, a fixed dollar amount off price discount, a free merchandise rebate price discount, and a combination discount thereof.

21. The method of claim 15, all the limitations of which are incorporated herein by reference, wherein a discount object command is created when said price discount group is selected, wherein said discount object command binds said price discounts to a respective item in said order.

22. A system for computing price discounts for an electronic commerce order comprising:
a first unit operable for categorizing applicable price discounts for an individual customer order;
a computer configured to said first unit and operable for computing valid combinations of price discounts for said individual customer order;
a component configured to said computer and operable for combining said valid combinations of price discounts into a price discount group;
a processing control mechanism configured to said component and operable for processing subsets of price discount rules within said price discount group; and
a second unit configured to said component and operable for selecting an optimal price discount based on said price discount group.

23. The system of claim 22, all the limitations of which are incorporated herein by reference, further comprising a sequence of commands input into said computer, wherein said commands bind price discount information to a respective item in said electronic commerce order.

24. The system of claim 22, all the limitations of which are incorporated herein by reference, further comprising a disabling mechanism configured to said computer and operable for preventing gratuitous discounts from being applied to said electronic commerce order.

25. The system of claim 22, all the limitations of which are incorporated herein by reference, further comprising a priority controller mechanism configured to said computer and operable for prioritizing a sequential order of evaluating said price discount rules.

26. The system of claim 22, all the limitations of which are incorporated herein by reference, wherein said individual customer order comprises at least one order line item, wherein said at least one order line item comprises a unique item identifier, a quantity ordered identifier, and a price per unit identifier for each item being ordered, and wherein said unique item identifier comprises a stock keeping unit (SKU) identifier.

27. The system of claim 22, all the limitations of which are incorporated herein by reference, wherein said applicable price discounts are based on a customer's identity, date of order, identities of individual items purchased, combinations of items purchased, quantity of items purchased, and total price of items purchased.

28. The system of claim 22, all the limitations of which are incorporated herein by reference, wherein said price discounts comprise a fixed percentage off price discount, a fixed dollar amount off price discount, a free merchandise rebate price discount, and a combination discount thereof.

29. The system of claim 22, all the limitations of which are incorporated herein by reference, wherein a discount object command is created when said price discount group is selected, wherein said discount object command binds said price discounts to a respective item in said order.

30. A program storage device readable by computer, tangibly embodying a program of instructions executable by said computer to perform a method of computing price discounts for an electronic commerce order, said method comprising:
categorizing applicable price discounts for an individual customer order;
computing valid combinations of price discounts for said individual customer order;
combining said valid combinations of price discounts into a price discount group; and
selecting an optimal price discount based on said price discount group.

31. The program storage device of claim 30, all the limitations of which are incorporated herein by reference, wherein said individual customer order comprises at least one order line item.

32. The program storage device of claim 31, all the limitations of which are incorporated herein by reference, wherein said at least one order line item comprises a unique item identifier, a quantity ordered identifier, and a price per unit identifier for each item being ordered.

33. The program storage device of claim 32, all the limitations of which are incorporated herein by reference, wherein said unique item identifier comprises a stock keeping unit (SKU) identifier.

34. The program storage device of claim 30, all the limitations of which are incorporated herein by reference, wherein said applicable price discounts are based on a customer's identity, date of order, identities of individual items purchased, combinations of items purchased, quantity of items purchased, and total price of items purchased.

35. The program storage device of claim 30, all the limitations of which are incorporated herein by reference, wherein said price discounts comprise a fixed percentage off price discount, a fixed dollar amount off price discount, a free merchandise rebate price discount, and a combination discount thereof.

36. The program storage device of claim 30, all the limitations of which are incorporated herein by reference, wherein a discount object command is created when said price discount group is selected, wherein said discount object command binds said price discounts to a respective item in said order.
